(19) United States
(12) Patent Application Publication
(10) Pub. No.: US 2010/0049607 A1
(43) Pub. Date: Feb. 25, 2010

(54) METHOD AND SYSTEM FOR IMPRESSING KNOWLEDGE ADVERTISING

(75) Inventors: Woosung Lee, Seoul (KR); Mi Jeong Choi, Seoul (KR)

Correspondence Address: H.C. PARK & ASSOCIATES, PLC, 8500 LEESBURG PIKE, SUITE 7500, VIENNA, VA, 22182, US

(73) Assignee: NHN Business Platform Corporation, Seongsam-si (KR)

(21) Appl. No.: 12/523,605

(22) PCT Filed: Nov. 13, 2007
(86) PCT No.: PCT/KR07/05684

§ 371 Date: Jul. 17, 2009

(30) Foreign Application Priority Data
Jan. 19, 2007 (KR) 10-2007-0006321

(51) Int. Cl. G06Q 30/00; G06F 17/30

(52) U.S. Cl. 705/14.54; 705/14.69; 705/14.71; 705/27; 707/738; 707/E17.033; 707/769; 707/748; 707/E17.046; 707/E17.014

(57) ABSTRACT

A method and system for displaying a knowledge advertisement which can provide a knowledge document that is retrieved in response to a knowledge search request, and also can provide paid advertisement information of an advertiser, and thereby can create advertising effect using a knowledge search and also can prevent the abusive registration of poor advertising questions/answers is provided. Therefore, there may be provided a method and system for displaying a knowledge advertisement which can develop questions and answers corresponding to advertisement knowledge and generate a construction where a system operator can optimally inspect the questions and the answers, and thereby can prevent the abusive registration of advertising questions and answers.

### CROSS-REFERENCE TO RELATED APPLICATIONS

This application is the National Stage of International Application No. PCT/KR2007/005684, filed Nov. 13, 2007, and claims priority from and the benefit of Korean Patent Application No. 10-2007-0006321, filed on Jan. 19, 2007, which are both hereby incorporated by reference for all purposes as if fully set forth herein.

### BACKGROUND OF THE INVENTION

1. Field of the Invention

The present invention relates to a method and system for displaying a knowledge advertisement which can provide a knowledge document that is retrieved in response to a knowledge search request, and also can provide paid advertisement information of an advertiser, and thereby can create an advertising effect using a knowledge search and also can prevent the abusive registration of poor advertising questions/answers.

2. Discussion of the Background

With the developments in communication networks such as the Internet, various types of information are being exchanged using the communication networks. In particular, a knowledge service enables an exchanging of knowledge among Internet users regarding products, services, and the like. The knowledge service is becoming a major marketing target of an advertiser.

The knowledge service provides answer information of unspecific users corresponding to question information entered by a predetermined questioner. Generally, the question information relates to products or services. Therefore, the advertiser uses, as a marketing tool, answer information corresponding to the question information associated with the products or the services, and thereby promotes a product of the advertiser.

However, there is no knowledge service that can regulate poor answer information including advertisement information, can register as answer information only advertisement information with more than a predetermined level of quality, and the like. Therefore, when the advertiser abuses the above knowledge service to register exaggerated advertisement information as answer information, good-willed questioners may become victimized in the conventional knowledge service.

Accordingly, there is a need for a new type of a knowledge advertisement display model which can outperform the existing knowledge search service of providing only simple question-answer information, and thereby can display only answer information with more than a predetermined level of quality and provide a service user with information about a substantially necessary product or service.

### SUMMARY OF THE INVENTION

An aspect of the present invention provides a method and system for displaying a knowledge advertisement which can develop questions and answers corresponding to advertisement knowledge and generate a construction where a system operator can optimally inspect the questions and the answers, and thereby can prevent the abusive registration of advertising questions and answers.

Another aspect of the present invention also provides a method and system for displaying a knowledge advertisement which can display only an answer, which is verified by a system operator, in a most effective top display location of an answer region, and thus can improve the quality of a knowledge document.

Another aspect of the present invention also provides a method and system for displaying a knowledge advertisement which can assign to a selected advertiser an edit right about a knowledge document consisting of formally purchased questions and answers, and thereby can provide a communication tool between an advertiser and a service user and provide a good knowledge service.

Another aspect of the present invention also provides a method and system for displaying a knowledge advertisement which can assign an edit right to an advertiser who purchases the edit right, and thereby can prevent the abusive registration of one-line answer data. In this instance, the edit right enables the advertiser to control and manage various types of advertising one-line answer data that are registered in a one-line answer region.

Another aspect of the present invention also provides a method and system for displaying a knowledge advertisement which can provide various types of additional information to a knowledge document consisting of a formally purchased question and answer and thus can enable a service user to satisfy the curiosity of the service user using a knowledge service and readily access direct commercial transaction, product purchase, and the like.

According to an aspect of the present invention, there is provided a method of displaying a knowledge advertisement, the method including the steps of: selling an edit right about a knowledge document to an advertiser; receiving question data and answer data corresponding to the question data from the advertiser who purchases the edit right; storing the knowledge document in a database in association with a designated keyword wherein the knowledge document comprises the question data and the answer data; searching the database for a knowledge document corresponding to a search keyword when a service user enters the search keyword in a knowledge trade site; and displaying the retrieved knowledge document in a knowledge search region that is supported in the knowledge trade site.

According to another aspect of the present invention, there is provided a method of displaying a knowledge advertisement, the method including the steps of: collecting question data entered in a knowledge trade site, and providing an advertiser with the collected question data; selling to the advertiser an edit right about question data that is selected from the provided question data by the advertiser; receiving answer data corresponding to the selected question data from the advertiser who purchases the edit right; and displaying the answer data in a predetermined answer region of a knowledge search region that is supported in the knowledge trade site.

### BRIEF DESCRIPTION OF THE DRAWINGS

FIG. 1 illustrates an example of a knowledge document according to an exemplary embodiment of the present invention;

FIG. 2 is a block diagram illustrating an operation of a system for displaying a knowledge advertisement according to an exemplary embodiment of the present invention;

FIG. 3 is a block diagram illustrating a configuration of a system for displaying a knowledge advertisement according to an exemplary embodiment of the present invention;

FIG. 4 illustrates an example of a knowledge search region supported in a knowledge trade site according to an exemplary embodiment of the present invention;

FIG. 5 is a flowchart illustrating an operation of determining an edit right to sell to an advertiser based on the size of a payment price according to an exemplary embodiment of the present invention;

FIG. 6 is a flowchart illustrating an operation of determining an edit right to sell to an advertiser based on rolling according to an exemplary embodiment of the present invention;

FIG. 7 is a flowchart illustrating an operation of determining an edit right to sell to an advertiser based on an algorithm according to an exemplary embodiment of the present invention;

FIG. 8 is a flowchart illustrating an operation of determining an edit right to sell to an advertiser based on a bid for a fixed location according to an exemplary embodiment of the present invention;

FIG. 9 is a flowchart illustrating a method of displaying a knowledge advertisement according to an exemplary embodiment of the present invention; and

FIG. 10 is a flowchart illustrating a method of displaying a knowledge advertisement according to another exemplary embodiment of the present invention.

### DETAILED DESCRIPTION OF THE ILLUSTRATED EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

Hereinafter, a method and system for displaying a knowledge advertisement according to the present invention will be described.

The term ‘knowledge document’ used throughout the present specification denotes a type of result information that is retrieved in response to a knowledge search request from a service user. The knowledge document may include question data and answer data corresponding to the question data.

The answer data of the knowledge document may include advertisement information of an advertiser in association with a search keyword entered by the service user, or the question data directly entered by the service user. Therefore, the answer data may be used as a marketing tool to promote the advertiser or a commercial item of the advertiser. In addition to the advertisement information for promotion, the answer data may include link information, for example, network address information, for connecting between the service user and the advertiser, shopping mall link information for proceeding a product purchase procedure, text/image information for description of a product, banner information, and the like.

Specifically, in a knowledge service consisting of a question and an answer, the knowledge document may denote all information that enables an advertisement of a particular advertiser to be displayed for the service user using the question or the answer.

For examples, types of the knowledge document may include a) a question-and-answer type where the service user registers question data and the advertiser enters answer data corresponding to the question data, b) a search type where the advertiser registers both question data and answer data corresponding to the question data, maintains a database, and provides the data for the service user in response to a knowledge search request, and c) a one-line answer type where one-line answer data is registered among answer data within a limited capacity size due to a size limit.

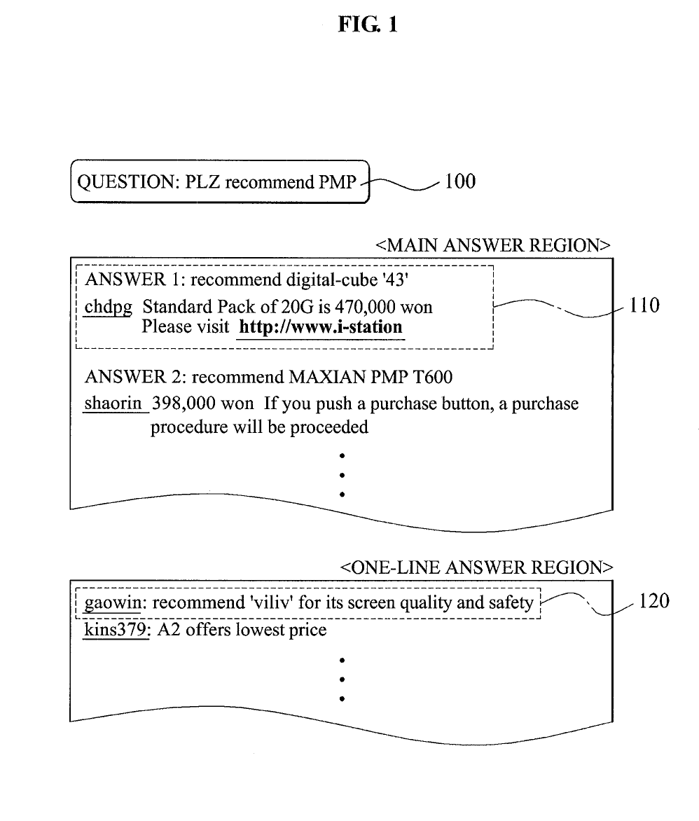

Hereinafter, a knowledge document registered by an advertiser will be described with reference to FIG. 1.

FIG. 1 illustrates an example of a knowledge document according to an exemplary embodiment of the present invention.

In FIG. 1, the knowledge document of c) the one-line answer type is shown as an example among the above-described various types of the knowledge document. The one-line answer type includes question data 100 and answer data including one-line answer data 120.

In the knowledge document, the answer data excluding the one-line answer data 120 (hereinafter, ‘main answer data’ 110) and the question data 100 may be registered in advance by the advertiser. The one-line answer data 120 may be registered by the advertiser, or by other advertisers or answerers.

For example, when a service user registers the question data 100, the main answer data 110 or the one-line answer data 120 may be registered by a plurality of advertisers.

As described above, the main answer data 110 may include link information for access to the advertiser, advertisement information for product promotion, and the like. Also, the main answer data 110 may include shopping mall link information for purchase of a product associated with a content that is included in the main answer data 110. The shopping mall link information may be a function to induce the service user to access a shopping mall selling a corresponding product. Also, the shopping mall link information may be a function to enable a purchase procedure of the corresponding product to be performed in a knowledge trade site providing a knowledge service, without converting to another page.

The one-line answer data 120 denotes a type of answer data that is registered in a one-line region with size limit information, among answer data registered by the advertiser. For example, the one-line answer data 120 may include information about a brief introduction or promotion of a product within a limited number of characters.

Referring to FIG. 1, in response to question data ‘PLZ recommend PMP’, the knowledge document includes the main answer data 110 that are registered by a plurality of advertisers, for example, ‘chdpg’ and ‘shaorin’, and the one-line answer data 120 that are registered by a plurality of advertisers, for example, ‘goawin’ and ‘kins379’. The main answer data 110 registered by the advertiser ‘chdpg’ includes link information, ‘http://www.i-station’, about a website of the advertiser ‘chdpg’. The main answer data 110 registered by the advertiser ‘shaorin’ includes shopping mall link information for purchase of product ‘MAXIAN PMP T600’. In this instance, when the knowledge document is displayed for the service user and the service user clicks the link information or the shopping mall link information, a knowledge advertisement display system according to the present invention may connect the service user to the advertiser ‘chdpg’, or enable the purchase procedure of the product ‘MAXIAN PMP T600’ that is promoted by the advertiser ‘shaorin’.

When registering answer data, the knowledge advertisement display system may allow only an advertiser who purchases an edit right to enter the answer data. Therefore, it is possible to prevent the abusive registration of advertising answer data. Specifically, the knowledge advertisement display system charges registration of answer data and allows only answer data with more than a predetermined level of quality to be registered using a predetermined registration procedure.

The edit right designates an answer region where the advertiser may display answer data of the advertiser, or a display location within the answer region. The edit right may be sold to the advertiser based on various types of elements. According to the present exemplary embodiment, it is possible to sell the edit right that designates the display location within the answer region for displaying the answer data of the advertiser, based on an input location or a payment price entered by the advertiser.

For example, when the advertiser ‘chdpg’ enters the input location ‘main answer region’ and the payment price ‘1,000 won’ in order to register answer data corresponding to question data ‘PLZ recommend PMP’, the knowledge advertisement display system may sell the edit right that is designed to display the main answer data 110 of the advertiser ‘chdpg’ in a display location corresponding to the payment price ‘1,000 won’ among display locations within the main answer region. The knowledge advertisement display system may compare the payment price ‘1,000 won’ of the advertiser ‘chdpg’ with another payment price ‘900 won’ of another advertiser ‘shaorin’ who desires to enter answer data in the same main answer region with respect to the same question data, and thereby determine a display location that is designated by the edit right sold to each advertiser. In FIG. 1, the edit right capable of displaying the main answer data in a top display location of the main answer region is sold to the advertiser ‘chdpg’ who enters a higher payment price, based on a payment price comparison scheme.

As another example, when the advertiser ‘goawin’ enters the input location ‘one-line answer region’ and a predetermined amount of payment price in order to register answer data corresponding to the question data ‘PLZ recommend PMP’, the knowledge advertisement display system may sell to the advertiser ‘goawin’ the edit right capable of displaying the one-line answer data 120 with the limited size in the one-line answer region. The advertiser ‘goawin’ who purchases the edit right may be assigned with the right capable of displaying one-line answer data of the advertiser ‘goawin’ in a top display location of the one-line answer region. In this case, the edit right may be sold as a ticket type.

In particular, according to the present invention, an advertiser who has the edit right capable of registering one-line answer data in the one-line answer region may be assigned with a management capacity about the one-line answer data of another advertiser or an answer, which is entered in the one-line answer region. Therefore, it is possible to prevent the misuse of the one-line answer data. For example, the advertiser ‘goawin’ who purchases the edit right about the one-line answer region may be assigned with the management capacity capable of deleting the one-line answer data of advertiser ‘kins379’ that is entered in the one-line answer region.

According to another exemplary embodiment of the present invention, the knowledge advertisement display system may compare the payment price of the advertiser ‘goawin’ with another payment price of the advertiser ‘kins379’ who desires to enter answer data in the same one-line answer region with respect to the same question data, and thereby determine a display location that is designated by the edit right sold to each advertiser. In FIG. 1, the edit right that sequentially designates display locations within the one-line answer region is sold based on the amount of the payment price.

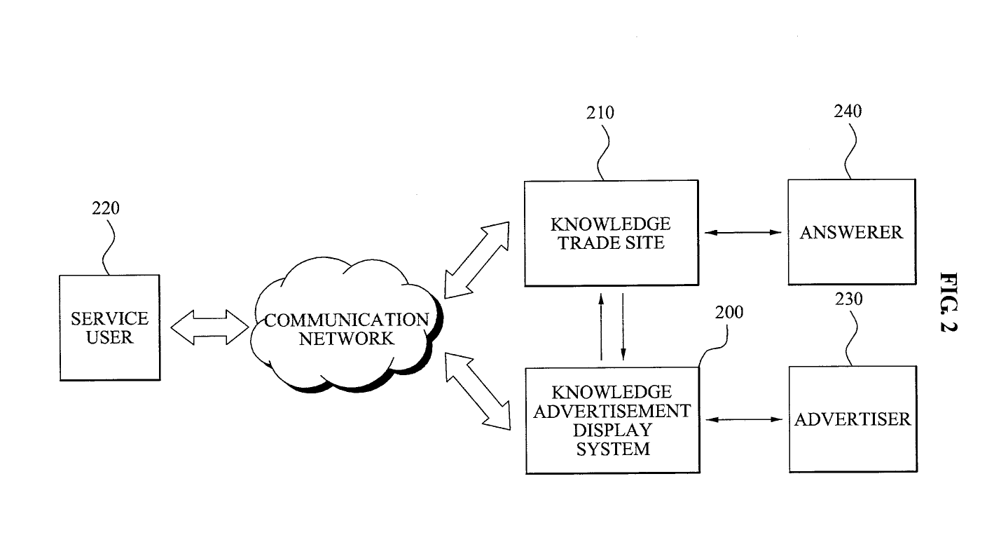

FIG. 2 is a block diagram illustrating an operation of a system 200 for displaying a knowledge advertisement according to an exemplary embodiment of the present invention.

An advertiser 230 registers a knowledge document that includes question data 100 and answer data that includes advertisement information and corresponds to the question data 100. As search results are generated in response to a knowledge search request from a service user 220, the advertiser 230 provides the knowledge document for the service user 220 via the knowledge advertisement display system 200. For example, the knowledge document of FIG. 1 may include the question data 100 ‘PLZ recommend PMP’ and the main answer data 110 including advertisement information ‘recommend digital-cube 43’. As the knowledge document is provided for the service user 220, the advertiser 230 may obtain advertising effect of displaying advertisement information of the advertiser 230 for the service user 220. Also, the advertiser 230 may enter answer data corresponding to the question data 100 that the service user 220 registers in a knowledge trade site 210, and register the knowledge document.

In response to a knowledge search request from the service user 220, the knowledge advertisement display system 200 may provide a knowledge document that is more related to an entered search keyword. Through this, advertisement information associated with the advertiser 230 may be displayed for the service user 220 and thus advertising effect may be accomplished.

Various types of known schemes may be used for identifying the knowledge document that is more related to the search keyword. In the present exemplary embodiment, it is possible to identify the knowledge document as search results by using a matching degree between the search keyword entered by the service user 220 for the knowledge search request and a keyword purchased by the advertiser 230 when registering the knowledge document.

The knowledge trade site 210 functions to provide a knowledge service using a question and an answer between the service user 220 and the advertiser 230, or between the service user 220 and an answerer 240. For example, the knowledge trade site 210 may receive the search keyword from the service user 220. In response to the search keyword, the knowledge advertisement display system 200 may provide a retrieved knowledge document for the service user 220. Also, the knowledge trade site 210 may receive the question data 100 from the service user 220, and record and maintain the question data 100 in a predetermined database. The knowledge trade site 210 may collect and provide the question data 100 for the advertiser 230 or the answerer 240 who accesses the knowledge trade site 210. The knowledge trade site 210 receives from the advertiser 230 or the answerer 240 answer data corresponding to the question data 100. In this instance, the advertiser 230 denotes a knowledge service user who includes advertisement information in the answer data with respect to the question data, and registers the answer data. The answerer 240 denotes a general knowledge service user who registers the answer data excluding the advertisement information.

Specifically, the knowledge trade site 210 functions to receive the question data 100 or answer data from users who use a knowledge service, and provide the service user 220 with the knowledge document as the search results in response to the knowledge search request. As described above, the knowledge document includes question data and answer data. Therefore, the service user 220 may receive the answer data corresponding to the registered question data. Also, instead of directly registering the question data, the service user 220 may retrieve a knowledge document similar to a desired question of the service user 220.

The service user 220 may denote an Internet user who has a user terminal to access the knowledge advertisement display system 200, and enters a query of the service user 220 in the knowledge trade site 210 in a question type using the user terminal, or enters the search keyword to generate the knowledge search request.

The service user 220 may be classified into the Internet user who enters the search keyword in the knowledge trade site 210 for the knowledge search of a previously registered knowledge document, and the Internet user who registers the query of the service user 220 in the knowledge trade site 210 as question data and waits for answer data of another advertiser 230 or the answerer 240.

The advertiser 230 may denote a product seller who operates a commercial website of which a location is identified by a network address, for example, an Internet Protocol (IP) address, a Universal Resource Locator (URL), a domain, and the like, in the network. For example, the advertiser 230 may enter answer data corresponding to predetermined question data in the knowledge trade site 210. The answer data includes advertisement information associated with a product being sold at the commercial site.

The answerer 240 may denote a general knowledge service user who enters answer data excluding the advertisement information with respect to the registered question data.

The knowledge advertisement display system 200 provides, as search results, the service user 220 with the knowledge document that matches the search keyword entered for the knowledge search request, and thereby provides the service user 220 with advertisement information included in the answer data of the knowledge document. In particular, the knowledge advertisement display system 200 may assign to the particular advertiser 230 the edit right that allows the right of entering answer data corresponding to question data. Also, the knowledge advertisement display system 200 may display answer data of the advertiser 230 in the display location of the answer region with guaranteed advertising effect. Therefore, it is possible to guarantee maximized advertising effect for the advertiser 230 and prevent the abusive registration of poor advertising questions and answers.

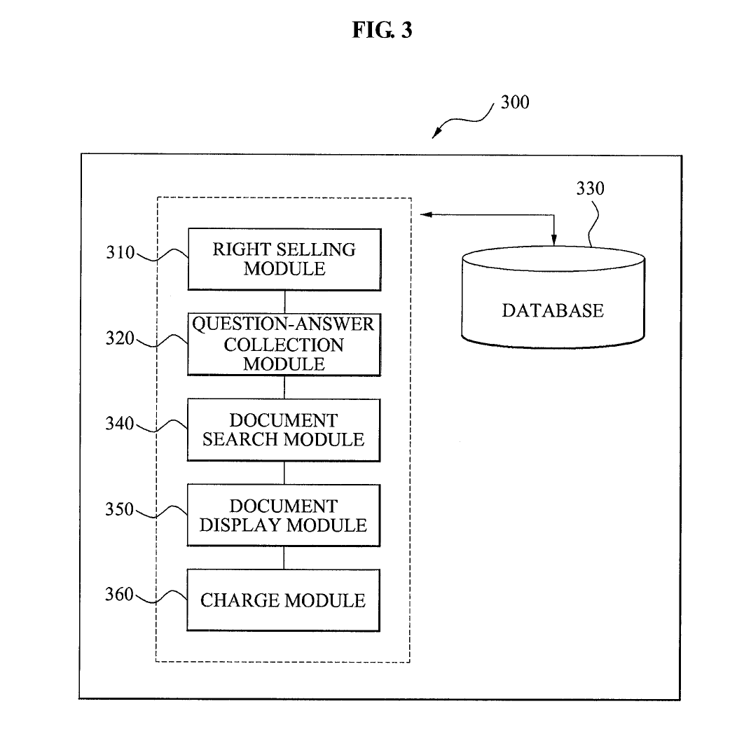

Hereinafter, a configuration of a knowledge advertisement display system according to the present invention will be described with reference to FIG. 3.

FIG. 3 is a block diagram illustrating a configuration of a system 300 for displaying a knowledge advertisement according to an exemplary embodiment of the present invention.

The knowledge advertisement display system 300 includes a right selling module 310, a question-answer collection module 320, a database 330, a document search module 340, and a document display module 350.

The right selling module 310 sells an edit right about a knowledge document to the advertiser 230. The edit right may denote a right capable of entering the question data 100, the main answer data 110, and the one-line answer data 120 of the knowledge document, a right capable of displaying the entered answer data in a designated answer region or a display location of the answer region, and a right capable of managing the one-line answer data 120 of another advertiser/answerer 240 that is registered in the one-line answer region, and the like. Specifically, the right selling module 310 receives a predetermined amount of payment according to registration of the knowledge document of the advertiser 230 who uses the knowledge service. With respect to the payment, the right selling module 310 assigns a particular ability to the corresponding advertiser 230. Through this, it is possible to improve the quality of the knowledge service and reduce the abusive registration of poor advertising questions and answers.

The edit right may be exclusively sold to the advertiser 230 who is selected through a predetermined procedure. Also, the edit right may be sold to the advertiser 230 who satisfies a payment condition for each display location in the answer region that is set by the operator of the present system, or to the advertiser 230 who is selected based on a payment price comparison between a plurality of advertisers 230 who desire to display answer data in a particular answer region or the display location of the answer region.

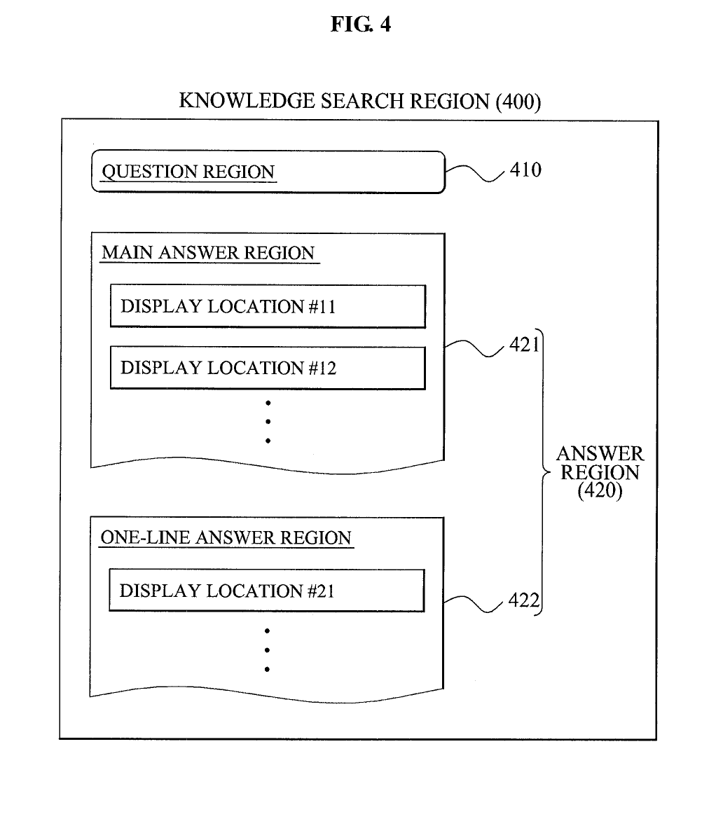

Hereinafter, a knowledge search region for displaying a knowledge document will be described with reference to FIG. 4.

FIG. 4 illustrates an example of a knowledge search region 400 supported in the knowledge trade site 210 according to an exemplary embodiment of the present invention.

The knowledge trade site 210 providing a knowledge service supports the knowledge search region 400 and displays in the knowledge search region 400 the knowledge document that includes the question data 100 and answer data corresponding to the question data 100. Through this, the knowledge trade site 210 displays advertisement information of the advertiser 230 for the service user 220 in a question-and-answer type.

The knowledge search region 400 includes a question region 410 and an answer region 420. The question region 410 displays question data 100 entered by the service user 220 or the advertiser 230. The answer region 420 displays answer data that is entered by the advertiser 230 and corresponds to the question data 100. Also, the answer region 420 may be classified into a main answer region 421 and a one-line answer region 422 based on the feature of the answer data displayed in the answer region 420. The one-line answer region 422 includes size limit information. For example, the one-line answer region 422 may display the one-line answer data 120 with a predetermined number of characters. The main answer region 421 may display the main answer data 110. The main answer data 110 includes various types of information such as advertisement information associated with a product corresponding to the question data 100, link information for access to the advertiser 230, and the like.

The answer region 420 is classified into at least one display location. The answer data is independently displayed in each display location. In this instance, the display location of displaying the answer data may be designated based on an edit right purchased by the advertiser 230. For example, with respect to an advertiser A (payment price 50 won) and an advertiser B (payment price 40 won) who desire to display the main answer data 110 in a display location ‘#11’ of the main answer region 421, the knowledge advertisement display system 300 may select the advertiser A by comparing the payment prices of the advertisers A and B. The knowledge advertisement display system 300 may assign the selected advertiser A with an edit right associated with displaying the main answer data 110 in the display location ‘#11’ of the main answer region 421.

The size of regions included in the knowledge search region 400 or the number of display locations included in each region may be arbitrarily determined by the system operator based on a system environment. Also, the top display location of the one-line answer region 422 may be exclusively occupied by the one-line answer data of the advertiser 230 who purchases, in advance, the corresponding edit right and thereby be displayed.

With the assumption that the knowledge search region 400 is constructed as FIG. 4, the right selling module 310 receives from the advertiser 230 information about the input location of the answer data or the payment price. Specifically, the right selling module 310 functions to receive from the advertiser 230 the input location for identifying the answer region 420 desired by the advertiser 230 and the payment price about the maximum advertisement fee that is payable by the advertiser 230.

The right selling module 310 may select the advertiser 230 to sell the edit right based on the input location or the payment price, and sell the edit right to the selected particular advertiser 230.

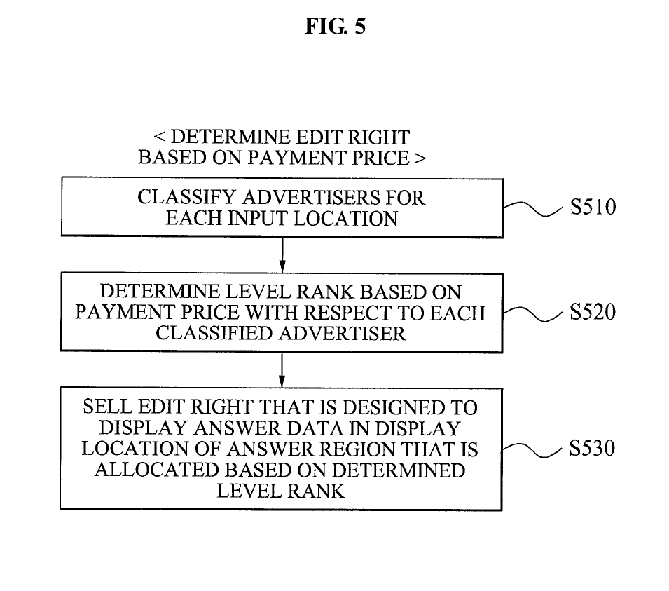

Hereinafter, an operation of selecting the advertiser 230 using the right selling module 310 will be described with reference to FIGS. 5 through 8.

FIG. 5 is a flowchart illustrating an operation of determining an edit right to sell to an advertiser based on the size of a payment price according to an exemplary embodiment of the present invention.

In operation S510, the right selling module 310 classifies advertisers 230 for each input location. Operation S510 is a process of grouping the advertisers 230 for the answer region 420 where the advertisers desire to display answer data. As shown in FIG. 4, the answer region 420 included in the knowledge search region 400 may be classified into the main answer region 421 and the one-line answer region 422. The advertiser 230 may enter either ‘a main answer region’ or ‘a one-line answer region’ as the input location, based on the feature of the answer data entered by the advertiser 230. Therefore, the right selling module 310 groups the advertisers 230 into a group of advertisers 230 who enter ‘the main answer region’ as the input location and another group of advertisers 230 who enter ‘the one-line answer region’ as the input location.

In operation S520, the right selling module 310 determines a level rank based on a payment price with respect to each classified advertiser 230. Operation S520 is a process of assigning a rank in a corresponding group to the grouped advertisers 230. In operation S520, the level rank is assigned to the advertiser 230 according to a descending rank based on the payment price. For example, with respect to the advertiser A (payment price 50 won) and the advertiser B (payment price 40 won) in association with the main answer region, the right selling module 310 may assign a first level rank to the advertiser A with the relatively greater amount of payment price and a second level rank to the advertiser B.

In operation S530, the right selling module 310 sells the edit right that is designed to display answer data of the corresponding advertiser 230 in a display location of the answer region 420. The display location is allocated based on the level rank. Operation S530 is a process of selecting the advertiser 230 based on the level rank and selling the edit right to the selected advertiser 230 according to the level rank. For example, when the maximum of two answer data can be registered in the main answer region 421, the right selling module 310 may select the advertiser A at the first level rank and the advertiser B at the second level rank. The right selling module 310 may sell to the advertiser A the edit right that is designed to display answer data in the top display location ‘#11’ of the main answer region 421. The top display location #11 is allocated to the first level rank. Also, the right selling module 310 may sell to the advertiser B the edit right that is designed to display answer data in a next top display location ‘#12’ of the main answer region 421. The next top display location ‘#12’ is allocated to the second level rank.

Therefore, according to the present invention, it is possible to sell, to the advertiser 230 who enters a relatively higher payment price, the edit right that is designed to display answer data in a display location of the answer region 420 with relatively excellent advertising effect. Therefore, it is possible to guarantee better benefits for the system operator through the competition between the advertisers 230.

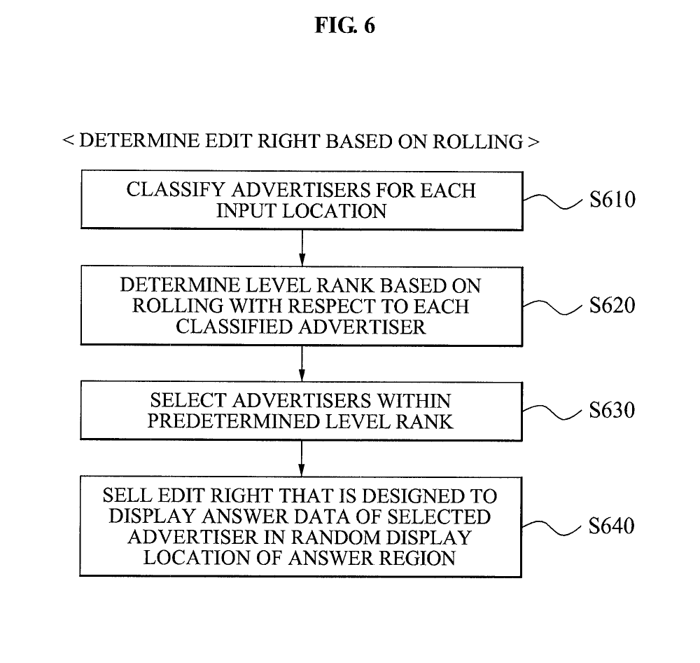

FIG. 6 is a flowchart illustrating an operation of determining an edit right to sell to an advertiser based on rolling according to an exemplary embodiment of the present invention.

In operation S610, the right selling module 310 classifies advertisers 230 for each input location. Operation S610 is the same or similar as operation S510 of FIG. 5. In the above example, the right selling module 310 may group the advertisers 230 into a group of advertisers 230 who enter ‘the main answer region’ as the input location and another group of advertisers 230 who enter ‘the one-line answer region’ as the input location.

In operation S620, the right selling module 310 determines the level rank based on the payment price, with respect to each classified advertiser 230. Operation S620 is the same or similar as operation S520 of FIG. 5. As described above, with respect to the advertiser A (payment price 50 won) and the advertiser B (payment price 40 won) associated with the main answer region, the right selling module 310 may assign a first level rank to the advertiser A with the relatively greater amount of payment price and a second level rank to the advertiser B.

In operation S630, the right selling module 310 selects the advertiser 230 within a predetermined level rank. Operation S630 is a process of selecting the advertiser 230 based on the determined level rank. For example, when the maximum of five answer data can be registered in the main answer region 421, the right selling module 310 may select the advertisers 230 within a fifth level rank, including the advertiser A at the first level rank and the advertiser B at the second level rank.

In operation S640, the right selling module 310 sells the edit right that is designed to display answer data of the selected advertiser in a random display location of the answer region 420. Operation S640 is a process of determining the edit right to sell to the advertiser 230 by providing the edit right to designate each display location in the answer region 420 and randomly associating the advertisers 230 with the edit right.

For example, with respect to five selected advertisers 230 including the advertisers A and B, the right selling module 310 may randomly sell the edit right to the advertiser 230 based on rolling. Therefore, the advertiser 230 may display the answer data of the advertiser 230 in the random display location of the main answer region 421. The random display location is designated based on the edit right purchased by the advertiser 230.

Therefore, according to the present invention, it is possible to randomly assign the edit right to each advertiser according to rolling, regardless of the payment price and thereby bring the equivalent advertising effect to the advertiser. Also, it is possible to prevent the abusive input of the payment price between advertisers.

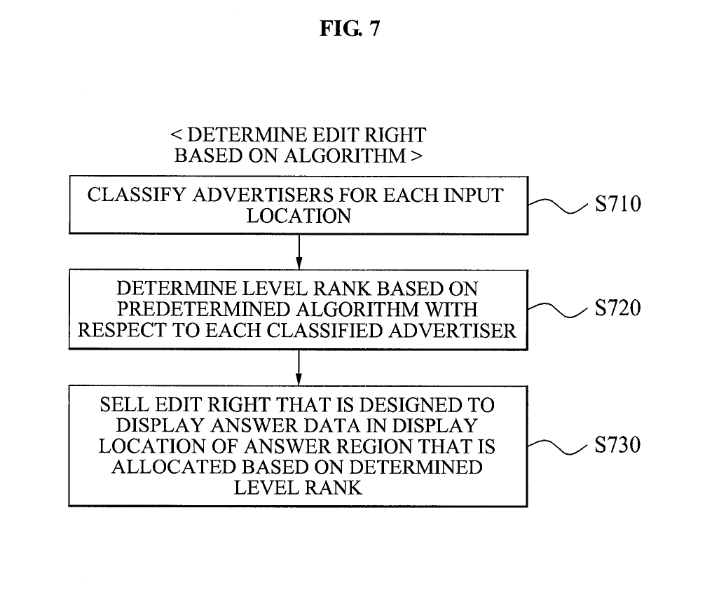

FIG. 7 is a flowchart illustrating an operation of determining an edit right to sell to an advertiser based on an algorithm according to an exemplary embodiment of the present invention.

In operation S710, the right selling module 310 classifies advertisers 230 for each input location. Operation S710 is the same or similar as operation S510 of FIG. 5. In the above example, the right selling module 310 may group the advertisers 230 into a group of advertisers 230 who enter ‘the main answer region’ as the input location and another group of advertisers 230 who enter ‘the one-line answer region’ as the input location.

In operation S720, the right selling module 310 determines the level rank according to a predetermined algorithm, with respect to each classified advertiser 230. Operation S720 is an operation of assigning a rank to each of the grouped advertisers 230. The right selling module 310 determines the level rank by applying the algorithm selected by the system operator. The algorithm is to analyze actual results and thereby determine the level rank for each advertiser 230. The actual results are generated in association with the particular advertiser 230 or the knowledge document during a predetermined period of time. For example, the algorithm may include reliability and popularity during a previous month regarding answer data that is registered by the advertiser 230. The popularity is based on an access rate of the service user 220 and the reliability is based on the rating of the service user 220. The algorithm may be selected by the system operator. In the above example, with respect to the advertiser A (popularity 40%) and the advertiser B (popularity 50%) that are grouped in association with ‘the main answer region’, the right selling module 310 may assign a first level rank to the advertiser B and a second level rank to the advertiser A. This is because more service users 220 click link information of the answer data and thus the popularity of the advertiser B is relatively higher.

In operation S730, the right selling module 310 sells the edit right that is designed to display the answer data of the corresponding advertiser 230 in the display location of the answer region 420. The display location is allocated based on the level rank. Operation S730 is the same or similar as operation S530 of FIG. 5. In the above example, when the maximum of two answer data is registered in the main answer region 421, the right selling module 310 may select the advertiser A at the second level rank and the advertiser B at the first level rank. The right selling module 310 may sell to the advertiser B the edit right that is designed to display answer data in the top display location ‘#11’ of the main answer region 421. The top display location #11 is allocated to the first level rank. Also, the right selling module 310 may sell to the advertiser A the edit right that is designed to display answer data in the next top display location ‘#12’ of the main answer region 421. The next top display location ‘#12’ is allocated to the second level rank.

Therefore, according to the present invention, it is possible to sell to the advertiser 230 who maintains good achievements during a predetermined knowledge service period, the edit right that is designed to display answer data in a display location of the answer region 420 with relatively excellent advertising effect. Therefore, it is possible to enable the advertiser 230 to maintain good quality information and service.

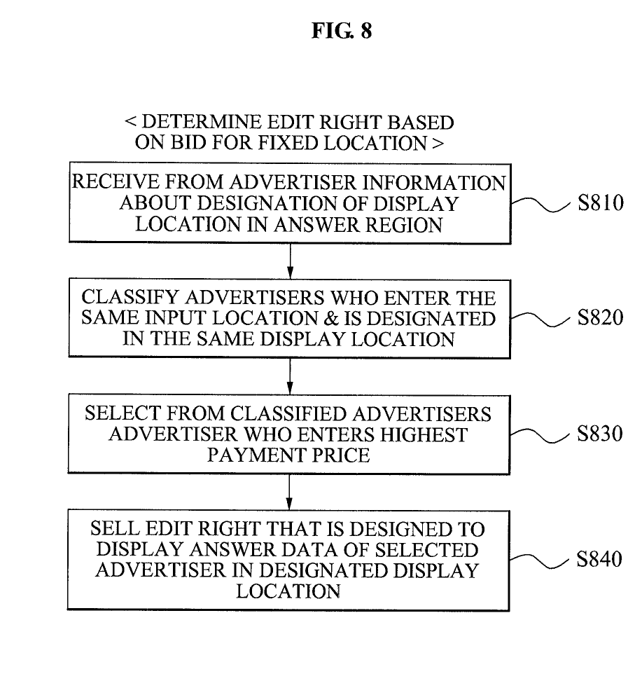

FIG. 8 is a flowchart illustrating an operation of determining an edit right to sell to an advertiser based on a bid for a fixed location according to an exemplary embodiment of the present invention.

In operation S810, the right selling module 310 receives from the advertiser 230 information about the designation of the display location in the answer region 420. Operation S810 is a process of receiving, in advance from the advertiser 230, the display location for displaying answer data. In operation S810, the advertiser 230 may determine the display location in the answer region 420 where the advertiser 230 desires to display the answer data, based on a marketing environment, and enter the designation information.

In operation S820, the right selling module 310 receives the same input location and classifies the advertisers 230 that designate the same display location. Operation S820 is a process of grouping the advertisers 230 according to the answer region 420 and the display location in the answer region 420 where the advertiser 230 desires to display answer data. For example, the right selling module 310 may classify into the same group the advertisers A and B who enter ‘the main answer region’ as the input location and enter ‘the display location ‘#11’ in the main answer region’ as the display location.

In operation S830, the right selling module 310 selects from the classified advertisers 230 the advertiser 230 who enters a highest payment price. Operation S830 is a process of selecting a single advertiser through the payment price comparison between the plurality of advertisers 230 who desires to display the answer data in a particular display location of a particular answer region. For example, with respect to the advertiser A (payment price 50 won) and the advertiser B (payment price 40 won) who are grouped into the same group associated with the display location #11 of the main answer region, the right selling module 310 may select from the advertisers 230 in the group the advertiser A who enters the highest payment price. Accordingly, the right selling module 310 may generate an environment capable of assigning to the single advertiser 230 a right capable of displaying the answer data in the particular display location of the particular answer region.

In operation S840, the right selling module 310 sells the edit right that is designed to display the answer data of the selected advertiser 230 in the designated display location. Operation S840 is a process of selling to the selected advertiser 230 the edit right that designates the display location in the corresponding answer region. In the above example, it is possible to sell to the advertiser A the edit right that is designed to display the answer data of the advertiser A in ‘the display location #11 of the main answer region’.

As described above, according to the present invention, it is possible to select the advertiser 230 who can purchase the edit right through a bid for each display location in the particular answer region. Therefore, it is possible to fundamentally prevent the answer data of the advertiser 230 from displaying in the display location where the advertiser 230 does not desire to display the answer data.

In the above example, the advertiser 230 enters ‘the main answer region’ as the input location. When the one-line answer region is entered as the input location, the advertiser selection scheme using the right selling module 310 may be the same or similar as when ‘the main answer region’ is entered as the input location. In this instance, the one-line answer region 422 includes size limit information about the entered answer data, that is, the one-line answer data. Therefore, the edit right sold to the advertiser 230 in association with the one-line answer region 422 may include a function of limiting the number of characters in the one-line answer data when the advertiser 230 enters the answer data.

Also, the right selling module 310 may sell the edit right that is designed to display the answer data of the advertiser 230 who is classified into the one-line answer group, in a higher display location of the one-line answer region 422 than the answer data of another advertiser or the answerer 240 who does not purchase the edit right. In particular, the edit right may be sold as a ticket type. The advertiser 230 who purchases the edit right may display, in advance, the answer data of the advertiser 230 in the top display location, that is, the display location ‘#21’ of the one-line answer region 422.

Also, the right selling module 310 may sell the edit right that is designed to assign the management capability of the one-line answer region 422 to the advertiser 230. Therefore, the advertiser 230 who purchases the edit right in association with the one-line answer region 422 may be assigned with the management capability that includes an ability of restricting display of the answer data of the other advertiser or the answerer 240 who does not purchase the edit right in the one-line answer region 422, or an ability of deleting the answer data from the one-line answer region 422.

Specifically, the right selling module 310 may sell the edit right to the advertiser 230 who satisfies a predetermined condition, and enable the advertiser 230 to register answer data that includes advertisement information.

Referring again to FIG. 3, the question-answer collection module 320 receives the question data 100 and answer data corresponding to the question data 100 from the advertiser 230 who purchases the edit right. Specifically, when the knowledge document is in b) the search type, the question-answer collection module 320 may simultaneously receive from the advertiser 230 the question data 100 and the answer data corresponding to the question data 100.

In particular, when the knowledge document is in a) the question-and-answer type, the question-answer collection module 320 collects the question data 100 of the service user 220 entered into the knowledge trade site 210, and provides the collected question data 100 for the advertiser 230. Also, the question-answer collection module 320 may enable the edit right about the question data 100 that is selected by the advertiser 230 from the provided question data 100 to be sold to the corresponding advertiser 230 using the right selling module 310. Also, the question-answer collection module 320 may receive answer data corresponding to the selected question data 100 from the advertiser 230 who purchases the edit right.

Specifically, the question-answer collection module 320 functions to collect the question data 100 and the answer data corresponding to the question data 100, and thereby generate the knowledge document.

When generating the knowledge document, the question-answer collection module 320, with the assumption that the question data 100 is registered in the question region 410, may register the answer data of the advertiser 230 in the answer region 410 that is designated by the edit right, or a display location of the answer region 410. The answer region 410 may include the main answer region 421 and the one-line answer region 422.

The database 330 stores the knowledge document in association with a designated keyword. As described above, the knowledge document includes the question data 100 and answer data corresponding to the question data 100. Specifically, the database 330 functions to store the keyword corresponding to the knowledge document. In this instance, the keyword causes a particular knowledge document to be retrieved in response to a knowledge search request from the service user 220.

As the service user 220 enters a search keyword in the knowledge trade site 210, the document search module 340 searches the database 330 for a knowledge document corresponding to the search keyword. Specifically, the document search module 340 functions to retrieve the knowledge document that the service user 220 desires to retrieve using the knowledge service. The search keyword is selected by, for example, the system operator or the advertiser 230 associated with the knowledge document. The knowledge search module 340 may search the database 330 for the knowledge document that partially or completely matches the search keyword.

The document display module 350 displays the retrieved knowledge document in the knowledge search region 400 that is supported in the knowledge trade site 210. Specifically, the document display module 350 functions to display for the service user 220 the answer data of the knowledge document that includes advertisement information of the advertiser 230 using the knowledge service (see FIG. 1).

In particular, the document display module 350 may analyze a content of the question data 100 or the answer data of the retrieved knowledge document according to a predetermined display allowance criterion. Also, the document display module 350 may display only the knowledge document of the question data 100 or the answer data that satisfies the display allowance criterion. For example, when the display allowance criterion is ‘No display for minors’, the document display module 350 verifies predetermined personal data and thereby identifies an age of the service user 220 who generates the knowledge search request. When the service user 220 is identified as a minor, the document display module 350 may not display the knowledge document for the corresponding service user 220.

According to another exemplary embodiment of the present invention, the document display module 350 may display the answer data of the advertiser 230 who purchases the edit right and the corresponding question data 100 in a search region of a predetermined site excluding the knowledge trade site 210. For example, the document display module 350 may display the knowledge document including the question data 100 and the answer data, in ‘a search column’ of a domestic portal search site, for example, Naver (www.naver.com), and the like. Through this, the document display module 340 may display advertisement information of the advertiser 230 for Internet users in various types of categories including a knowledge search category.

Also, the knowledge advertisement display system 300 may further include a charge module 360. The charge module 360 charges the advertiser 230 for an advertisement fee when answer data of the knowledge document is displayed in the knowledge search region 400 or when the service user 200 clicks the answer data of the displayed knowledge document. In particular, the charge module 360 may adopt a cost per iMpression (CPM) in which the advertiser 230 is charged with the advertisement fee every time answer data is displayed for the service user 220, or a cost per click (CPC) in which the advertiser 230 is charged with the advertisement fee every time the service user 220 clicks link information included in the answer data. Therefore, the advertiser 230 may pay only the advertisement fee corresponding to the advertising effect. For example, when answer data of the advertiser A who enters the payment price ‘50 won’ is included in the knowledge document and thereby is displayed for the service user 220, the charge module 360 may determine ‘50 won’ as the advertisement fee for display of the answer data, and charge the advertiser 230 with ‘50 won’. Also, under the same condition, when the service user 220 clicks link information of the displayed answer data of the advertiser A and the service user 220 is connected to the advertiser 230, the charge module 360 may charge the advertiser 230 with the advertisement fee ‘50 won’.

Therefore, according to the present invention, it is possible to develop questions and answers corresponding to advertisement knowledge and generate a construction where a system operator can optimally inspect the questions and the answers, and thereby prevent the abusive registration of advertising questions and answers.

Also, according to the present invention, it is possible to display only an answer, which is verified by a system operator, in a most effective top display location of an answer region, and thus can improve the quality of a knowledge document.

Also, according to the present invention, it is possible to assign to a selected advertiser an edit right about a knowledge document consisting of formally purchased questions and answers, and thereby can provide a communication tool between an advertiser and a service user and provide a good knowledge service.

Also, according to the present invention, it is possible to assign an edit right to an advertiser who purchases the edit right, and thereby prevent the abusive registration of one-line answer data. In this instance, the edit right enables the advertiser to control and manage various types of advertising one-line answer data that are registered in a one-line answer region.

Also, according to the present invention, it is possible to provide various types of additional information to a knowledge document consisting of a formally purchased question and answer and thus enable a service user to satisfy the curiosity of the service user using a knowledge service and readily access direct commercial transaction, product purchase, and the like.

Hereinafter, an operation of a knowledge advertisement display system according to an exemplary embodiment of the present invention will be described.

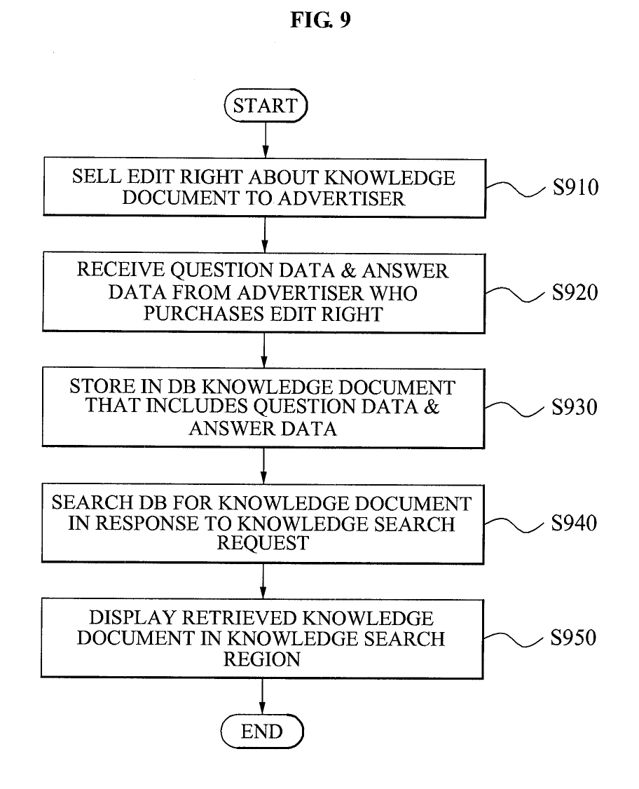

FIG. 9 is a flowchart illustrating a method of displaying a knowledge advertisement according to an exemplary embodiment of the present invention.

The method of displaying the knowledge advertisement is performed by the above-described knowledge advertisement display system 300.

In operation S910, the knowledge advertisement display system 300 sells an edit right about a knowledge document to the advertiser 230. Operation S910 is a process of determining a display location of answer data of the advertiser 230 in the knowledge search region 400 with respect to the knowledge document that includes question data and the answer data. For this, in operation S910, the knowledge advertisement display system 300 may receive from the advertiser 230 information about a payment price or an input location in association with display of the answer data of the advertiser 230, and identify the advertiser 230 based on the input location or the payment price. The knowledge advertisement display system 300 sells the edit right to the selected advertiser 230.

When selecting the advertiser 230, the knowledge advertisement display system 300 may select a predetermined number of advertisers 230 for the answer region or each display location in the answer region, based on 1) the payment price entered by the advertiser 230 (see description of FIG. 5), 2) rolling (see description of FIG. 6), 3) the predetermined algorithm (see description of FIG. 8), and 4) the bid for the fixed location (see description of FIG. 8).

In particular, in the case of the edit right that is sold to the selected advertiser 230 in association with the one-line answer region 422, the edit right may be designed to display, in advance, the one-line answer data 120 of the advertiser 230 in the top display location of the one-line answer region 422. Therefore, the advertiser 230 who purchases the edit right about the one-line answer region 422 may display, in advance, the answer data of the advertiser 230 in the display location with the most excellent advertising effect.

Also, in the case of the edit right that is sold to the selected advertiser 230 in association with the one-line answer region 422, the edit right may be designed to assign the management capability of the one-line answer region 422 to the corresponding advertiser 230. Therefore, the advertiser 230 who purchases the edit right about the one-line answer region 422 may restrict answer data of another advertiser or the answerer 240 who does not purchase the edit right to be displayed in the one-line answer region 422 using the management capability. For example, the knowledge advertisement display system 300 may sell to the advertiser 230 who purchases the edit right about the one-line answer region 422 the edit right that is designed to delete from the one-line answer region 422 other answer data, excluding the answer data of the advertiser 230.

In operation S920, the knowledge advertisement display system 300 receives question data and answer data corresponding to the question data from the advertiser 230 who purchases the edit right. The answer data may include at least one of link information for access to the advertiser 230, shopping mall link information for purchase of a product associated with a content included in the answer data, and advertisement information about the product. Specifically, when the knowledge document is in b) the search type, operation S920 is a process of receiving the question data from the advertiser 230 and subsequently receiving the answer data in the answer region or the display location of the answer region that is designated by the edit right. When the knowledge document is in a) the question-and-answer type, the knowledge advertisement display system 300 receives from the advertiser 230 the answer data corresponding to the question data of the service user 220 with respect to the answer region or the display location in the answer region that is designated by the edit right.

In operation S930, the knowledge advertisement display system 300 stores the knowledge document in the database 330 in association with a designated keyword. As described above, the knowledge document includes the question data and the answer data. Operation S930 is a process of maintaining the database 330 in which the knowledge document is stored in correspondence to the keyword. The knowledge document is provided for the service user 220 in response to the knowledge search request and the keyword causes the search of the knowledge document. The keyword associated with the knowledge document may be arbitrarily determined by the system operator or the advertiser 230.

In operation S940, as the service user 220 enters the search keyword in the search trade site 210, the knowledge advertisement display system 300 searches the database 330 for the knowledge document corresponding to the search keyword. Operation S940 is a process of extracting from the database 330 an optimal knowledge document in response to the knowledge search request from the service user 220. When retrieving the knowledge document, the knowledge advertisement display system 300 may retrieve as search results the knowledge document that partially or completely matches the search keyword.

In operation S950, the knowledge advertisement display system 300 displays the retrieved knowledge document in the knowledge search region that is supported in the knowledge trade site 210. Operation S950 is a process of displaying the retrieved knowledge document in the knowledge search region that is supported in the knowledge trade site 210. In particular, in operation S950, the knowledge advertisement display system 300 may individually display the answer data of the advertiser 230 who purchases the edit right in the display location of the answer region that is designated based on the edit right.

Also, in operation S950, the knowledge advertisement display system 300 may apply a predetermined display allowance criterion to the retrieved knowledge document. Only when a content of the question data or the answer data of the knowledge document satisfies the display allowance criterion, may the knowledge advertisement display system 300 display the knowledge document.

Also, in operation S950, the knowledge document display system 300 may charge the advertiser 230 with the advertisement fee in association with display of the knowledge document or the service user's 220 click on the answer data included in the knowledge document. Specifically, operation S950 is a process of charging the advertiser 230 with the advertisement fee according to a CPM, a CPC, and the like. The knowledge document display system 300 may charge the advertiser 230 with a reasonable advertisement fee in proportion to the obtained advertising effect, for example, a number of times that the service user 220 accesses a website/shopping mall site of the advertiser 230.

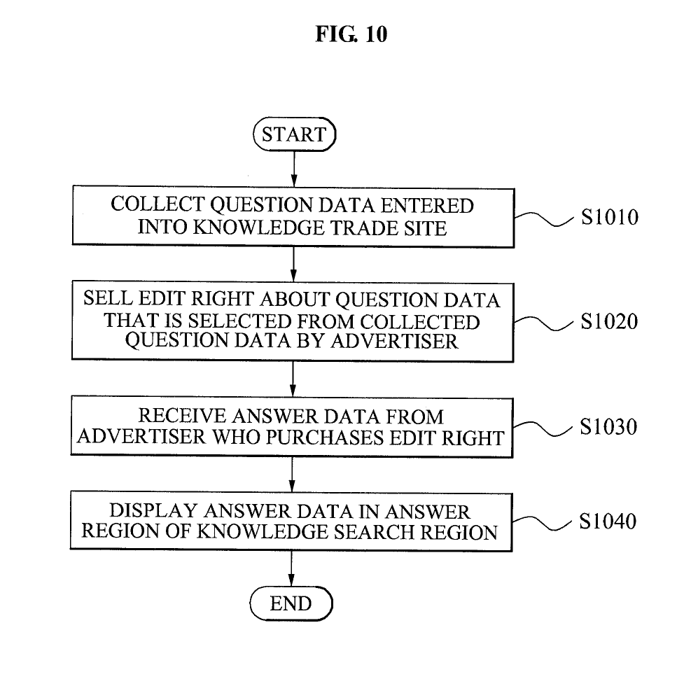

FIG. 10 is a flowchart illustrating a method of displaying a knowledge advertisement according to another exemplary embodiment of the present invention.

In operation S1010, the knowledge advertisement display system 300 collects question data entered into the knowledge trade site 210 and provides the advertiser 230 with the collected question data. Operation S1010 is a process of collecting the question data registered in the knowledge trade site 210 by the service user 220, listing the collected question data, and providing the advertiser 230 with the listed question data, when the knowledge document is in a) the question-and-answer type.

In operation S1020, the knowledge advertisement display system 300 sells to the advertiser 230 the edit right about question data that is selected from the provided question data by the advertiser 230. Operation S1020 is a process of receiving from the advertiser 230 the question data associated with the answer data of the advertiser 230. In operation S1020, the advertiser 230 may designate predetermined question data from the list of the question data, based on a marketing environment. The knowledge advertisement display system 300 performs a selling procedure of the edit right about the question data selected by the advertiser 230. For the selling procedure of the edit right, in operation S1020, the knowledge advertisement display system 300 receives from the advertiser 230 information about the input location or the payment price about display of the answer data of the advertiser 230, and sells the edit right to the selected advertiser 230 based on the input location or the payment price, which is the same as in operation S910. Detailed descriptions related to selection of the advertiser 230 will be the same as operation S910 and thus further descriptions will be omitted here.

In operation S1030, the knowledge advertisement display system 300 receives from the advertiser 230 who purchases the edit right answer data corresponding to the selected question data. Operation S1030 is a process of receiving from the advertiser 230 the answer data corresponding to the question data entered by the service user 220 with respect to the answer region or the display location of the answer region that is designated based on the edit right, when the knowledge document is in a) the question-and-answer type. In operation S1030, when the knowledge document is in b) the search type, the knowledge advertisement display system 300 may receive question data from the advertiser 230 and receive answer data in the answer region or the display location of the answer region that is designated based on the edit right.

In operation S1040, the knowledge advertisement display system 300 displays the answer data in the predetermined answer region of the knowledge search region that is supported in the knowledge trade site 210. Operation S1040 is a process of individually displaying the answer data of the advertiser 230 in the display location of the answer region that is designated based on the edit right.

Also, in operation S1040, the knowledge advertisement display system 300 may apply a predetermined display allowance criterion to the answer data. Only when a content of the answer data satisfies the display allowance criterion, may the knowledge advertisement display system 300 display the answer data in the answer region.

Also, in operation S1040, the knowledge advertisement display system 300 may charge the advertiser 230 with the advertisement fee in association with display of the answer data or the service user's 220 click on the displayed answer data. Specifically, operation S1040 is a process of charging the advertiser 230 with the advertisement fee according to a CPM, a CPC, and the like. The knowledge document display system 300 may charge the advertiser 230 with a reasonable advertisement fee in proportion to the obtained advertising effect, for example, a number of times that the service user 220 accesses a website/shopping mall site of the advertiser 230.

According to another exemplary embodiment of the present invention, the knowledge advertisement display system 300 may display the answer data of the advertiser 230 who purchases the edit right and corresponding question data in a search region of a predetermined site excluding the knowledge trade site 210. For example, the knowledge advertisement display system 300 may display the knowledge document including question data and answer data, in ‘a search column’ of a general search site. Through this, the knowledge advertisement display system 300 may display advertisement information of the advertiser 230 for Internet users in various types of categories including a knowledge search category.

Also, according to the present invention, it is possible to develop questions and answers corresponding to advertisement knowledge and generate a construction where a system operator can optimally inspect the questions and the answers, and thereby prevent the abusive registration of advertising questions and answers.

Also, according to the present invention, it is possible to display only an answer, which is verified by a system operator, in a most effective top display location of an answer region, and thus improve the quality of a knowledge document.

Also, according to the present invention, it is possible to assign to a selected advertiser an edit right about a knowledge document consisting of formally purchased questions and answers, and thereby provide a communication tool between an advertiser and a service user and provide a good knowledge service.

Also, according to the present invention, it is possible to assign an edit right to an advertiser who purchases the edit right, and thereby prevent the abusive registration of one-line answer data. In this instance, the edit right enables the advertiser to control and manage various types of advertising one-line answer data that are registered in a one-line answer region.

Also, according to the present invention, it is possible to provide various types of additional information to a knowledge document consisting of a formally purchased question and answer and thus enable a service user to satisfy the curiosity of the service user using a knowledge service and readily access direct commercial transaction, product purchase, and the like.

The exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

As described above, according to the present invention, there may be provided a method and system for displaying a knowledge advertisement which can develop questions and answers corresponding to advertisement knowledge and generate a construction where a system operator can optimally inspect the questions and the answers, and thereby can prevent the abusive registration of advertising questions and answers.

Also, according to the present invention, there may be provided a method and system for displaying a knowledge advertisement which can display only an answer, which is verified by a system operator, in a most effective top display location of an answer region, and thus can improve the quality of a knowledge document.

Also, according to the present invention, there may be provided a method and system for displaying a knowledge advertisement which can assign to a selected advertiser an edit right about a knowledge document consisting of formally purchased questions and answers, and thereby can provide a communication tool between an advertiser and a service user and provide a good knowledge service.

Also, according to the present invention, there may be provided a method and system for displaying a knowledge advertisement which can assign an edit right to an advertiser who purchases the edit right, and thereby can prevent the abusive registration of one-line answer data. In this instance, the edit right enables the advertiser to control and manage various types of advertising one-line answer data that are registered in a one-line answer region.

Also, according to the present invention, there may be provided a method and system for displaying a knowledge advertisement which can provide various types of additional information to a knowledge document consisting of a formally purchased question and answer and thus can enable a service user to satisfy the curiosity of the service user using a knowledge service and readily access direct commercial transaction, product purchase, and the like.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for displaying a knowledge advertisement, comprising:
selling an edit right about a knowledge document to an advertiser;
receiving question data and answer data corresponding to the question data from the advertiser who purchases the edit right;
storing the knowledge document in a database in association with a designated keyword, the knowledge document comprising the question data and the answer data;
searching the database for a knowledge document associated with a designated keyword corresponding to a search keyword if a service user enters the search keyword in a knowledge trade site; and
displaying the retrieved knowledge document in a knowledge search region of the knowledge trade site.

2. The method of claim 1, wherein the knowledge search region comprises a question region to display the question data and an answer region to display the answer data, and
the step of displaying the retrieved knowledge document comprises displaying the answer data in a display location of the answer region, wherein the display location is designated based on the edit right.

3. The method of claim 1, further comprising:
generating a display allowance criterion,
wherein the step of displaying the retrieved knowledge document comprises displaying the retrieved knowledge document only if the question data or the answer data of the knowledge document satisfies the display allowance criterion.

4. A method for displaying a knowledge advertisement, comprising:
collecting question data entered in a knowledge trade site, and providing an advertiser with the collected question data;
selling to the advertiser an edit right about question data that is selected from the provided question data by the advertiser;
receiving answer data corresponding to the selected question data from the advertiser who purchases the edit right; and
displaying the answer data in an answer region of a knowledge search region of the knowledge trade site.

5. The method of claim 4, wherein the step of displaying the answer data comprises displaying the answer data in a display location of the answer region, and the display location is designated based on the edit right.

6. The method of claim 4, further comprising:
generating a display allowance criterion,
wherein the step of displaying the answer data comprises displaying the answer data only if the answer data satisfies the display allowance criterion.

7. The method of claim 1, wherein the step of selling comprises:
receiving, from the advertiser, information about an input location of the answer data or a payment price;
selecting the advertiser based on the received input location or the payment price; and
selling the edit right to the selected advertiser.

8. The method of claim 7, wherein the step of selecting comprises:
classifying advertisers for each input location; and
determining a level rank of each classified advertiser based on the payment price corresponding to each classified advertiser,
wherein the step of selling comprises selling the edit right that is designed to display answer data of a corresponding advertiser in a display location of an answer region, and the display location is allocated based on the determined level rank.

9. The method of claim 7, wherein the step of selecting comprises:
classifying advertisers for each input location;
determining a level rank of each classified advertiser based on the payment price corresponding to each classified advertiser; and
selecting an advertiser within the determined level rank,
wherein the step of selling comprises selling the edit right that is designed to display answer data of the selected advertiser in a random display location of an answer region.

10. The method of claim 7, wherein the step of selecting comprises:
classifying advertisers for each input location; and
determining a level rank of each classified advertiser based on a predetermined algorithm executed for each classified advertiser,
wherein the step of selling comprises selling the edit right that is designed to display answer data of a corresponding advertiser in a display location of an answer region, and the display location is allocated based on the determined level rank.

11. The method of claim 7, wherein the step of selecting comprises:
receiving, from a plurality of advertisers, information about a designation of a display location in an answer region;
classifying advertisers who enter the same input location or are designated in the same display location; and
selecting from the classified advertisers an advertiser who enters a highest payment price,
wherein the step of selling comprises selling the edit right that is designed to display answer data of the selected advertiser in a designated display location of an answer region.

12. The method of claim 7, wherein a predetermined one-line answer region of the answer region comprises size limit information about answer data, and
the step of selecting comprises:
classifying as a one-line answer group an advertiser who receives the one-line answer region as information about the input location; and
determining a level rank of each classified advertiser based on the payment price corresponding to each classified advertiser,
wherein the step of selling comprises selling the edit right that is designed to display answer data of the advertiser in a display location of the one-line answer region, wherein the answer data satisfies the size limit information, and the display location is allocated based on the determined level rank.

13. The method of claim 12, wherein the step of selling further comprises selling the edit right that is designed to display the answer data of the advertiser who is classified into the one-line answer group in a higher display location of the one-line answer region than answer data of an advertiser who does not purchase the edit right.

14. The method of claim 12, wherein the step of selling further comprises:
selling the edit right that is designed to assign a management capacity about the one-line answer region to the advertiser,
wherein the management capacity comprises an ability to restrict a display of answer data of an advertiser who does not purchase the edit right in the one-line answer region.

15. The method of claim 1, further comprising:
charging the advertiser with an advertisement fee according to display of the answer data or a click of the service user on the displayed answer data,
wherein the advertisement fee is computed based on a payment price entered by the advertiser.

16. The method of claim 1, wherein the answer data comprises at least one of link information for access to the advertiser, retailer link information for purchase of an associated product, and advertisement information for promotion of the product.

17. The method of claim 1, further comprising:
displaying the question data and the answer data of the advertiser who purchases the edit right in a search region of a predetermined site, excluding the knowledge trade site.

18. A computer comprising a processor and a computer-readable recording medium storing a program, which when executed implements the method according to claim 1.

19. A system for displaying a knowledge advertisement, comprising:
a right selling module to sell an edit right about a knowledge document to an advertiser;
a question-answer collection module to receive question data and answer data corresponding to the question data from the advertiser who purchases the edit right;
a database to store the knowledge document in a database in association with a designated keyword, the knowledge document comprising the question data and the answer data;
a document search module to search the database for a knowledge document associated with a designated keyword corresponding to a search keyword if a service user enters the search keyword in a knowledge trade site; and
a document display module to display the retrieved knowledge document in a knowledge search region of the knowledge trade site.

20. The system of claim 19, wherein the right selling module a1) receives, from the advertiser, information about an input location of the answer data or a payment price, a2) selects the advertiser based on the received input location or the payment price, and a3) sells the edit right to the selected advertiser.

21. The system of claim 19, wherein a predetermined one-line answer region in the answer region comprises size limit information about answer data, and
the right selling module b1) receives, from the advertiser, information about an input location of the answer data or a payment price, b2) classifies the advertiser as a one-line answer group if the one-line answer is received from the advertiser as information about the input location, and determines a level rank for each classified advertiser based on the payment price corresponding to each classified advertiser, and b3) sells the edit right that is designed to display answer data of the advertiser in a display location of the one-line answer region, wherein the answer satisfies the size limit information, and the display location is allocated based on the determined level rank.

22. The system of claim 21, wherein the right selling module sells the edit right that is designed to display answer data of the advertiser who is classified into the one-line answer group in a higher display location of the one-line answer region than answer data of an advertiser who does not purchase the edit right.

23. The system of claim 21, wherein the right selling module sells the edit right that is designed to assign a management capacity about the one-line answer region to the advertiser, and the management capacity comprises an ability to restrict a display of answer data of an advertiser who does not purchase the edit right in the one-line answer region.
